(19) United States
(12) Patent Application Publication
(10) Pub. No.: US 2019/0302560 A1
(43) Pub. Date: Oct. 3, 2019

(54) LIQUID CRYSTAL PANEL AND LIQUID CRYSTAL DISPLAY DEVICE

(71) Applicant: SHARP KABUSHIKI KAISHA, Osaka (JP)

(72) Inventors: YASUNAO IWATA, Osaka (JP); JUNICHI MORINAGA, Sakai City (JP)

(21) Appl. No.: 16/372,807

(22) Filed: Apr. 2, 2019

(30) Foreign Application Priority Data
Apr. 3, 2018 (JP) 2018-071588

(51) Int. Cl. G02F 1/1362; G02F 1/1368

(52) U.S. Cl. CPC G02F 1/136286; G02F 2201/123; G02F 2201/121; G02F 1/1368

(57) ABSTRACT

The present invention realizes a liquid crystal panel which can prevent its production yield from being reduced due to a line defect, and also to ensure a high pixel aperture ratio. The liquid crystal panel includes: a first substrate; a second substrate; and liquid crystal being provided between the first substrate and the second substrate. The first substrate has provided thereon the followings: a plurality of first wirings; a plurality of second wirings each intersecting the first wirings via a first interlayer insulating film; a plurality of switching elements each being provided near a corresponding one of intersections between the first wirings and the second wirings; a third wiring extending from a corresponding one of the switching elements to a pixel electrode; and a fourth wiring being provided in a layer different from a layer including the third wiring, so as to at least partially overlap the third wiring.

This Nonprovisional application claims priority under 35 U.S.C. § 119 on Patent Application No. 2018-071588 filed in Japan on Apr. 3, 2018, the entire contents of which are hereby incorporated by reference.

### TECHNICAL FIELD

The present invention relates to a liquid crystal panel and a liquid crystal display device.

### BACKGROUND ART

A line defect, such as a wiring disconnection or a leakage between wirings, during production of a liquid crystal panel leads to a lowered production yield of the liquid crystal panel. The wiring encompasses not only a wiring for supplying a signal to individual pixels, which constitute a display region, but also a wiring for connecting, for example, a switching element and a pixel electrode in each pixel. In a case where a liquid crystal panel has even a single line defect, the liquid crystal panel is judged as being defective. For a high-definition panel and a large panel, it is particularly difficult to increase their production yield because these panels include a large number of wirings.

A line defect is caused mainly by a layout design. A drain line is often designed to be thin, so as to ensure a sufficient aperture ratio of each pixel. A high-definition panel and a large panel in particular include a large number of pixels and thus, are more likely to suffer from disconnection of a drain line during production. Such a disconnection hinders improvement in quality of a liquid crystal panel.

Patent Literature 1 discloses a liquid crystal display device that includes a data line and a redundant data line provided on the data line via an insulating film. The data line and the redundant data line are connected together via a contact hole.

Patent Literature 2 discloses a liquid crystal display device, in which a conductive layer d3 is formed on a second insulating film so as to overlap a region of a second signal line, which region includes an intersection with a first signal line. The conductive layer is connected to the second signal line via through holes provided in the second insulating film on both sides of the first signal line.

Patent Literature 3 discloses a liquid crystal display device and a method of manufacturing the same each of which can provide an auxiliary recovery line structure that enables reduction of a disconnected data line without the need for additional steps.

### CITATION LIST

### Patent Literature

[Patent Literature 1]

Japanese Patent Application Publication Tokukaihei No. 11-242243 (Publication Date: Sep. 7, 1999)

[Patent Literature 2]

Japanese Patent Application Publication Tokukai No. 2000-56335 (Publication Date: Feb. 25, 2000)

[Patent Literature 3]

Japanese Patent Application Publication Tokukaihei No. 11-194369 (Publication Date: Jul. 21, 1999)

### SUMMARY OF INVENTION

### Technical Problem

According to the liquid crystal display device of Patent Literature 1, a contact hole is formed near a pixel opening. Such a contact hole raises a concern about a display defect. The contact hole raises another concern about a defect such as a light leakage since the contact hole impairs flatness of each pixel and thus leads to deficiencies in orientation of liquid crystal.

Further, in a case where a layer of a pixel electrode or the like is used to prepare for disconnection of a drain line, based on the techniques of Patent Literatures 2 and 3, the pixel electrode and other components are deformed. This suggests a possibility that a display quality of a liquid crystal display device is lowered.

The present invention has been accomplished in view of the foregoing problem, and an object of the present invention is to provide a liquid crystal panel which makes it possible to prevent its production yield from being reduced due to a line defect and also to ensure a high pixel aperture ratio.

### Solution to Problem

In order to achieve the foregoing object, a liquid crystal panel in accordance with an aspect of the present invention includes: a first substrate; a second substrate; and liquid crystal being provided between the first substrate and the second substrate, wherein the first substrate has provided thereon the followings: a plurality of first wirings; a plurality of second wirings each intersecting a corresponding one of the first wirings via a first interlayer insulating film; a plurality of switching elements each being provided near a corresponding one of intersections between the first wirings and the second wirings; a third wiring extending from a corresponding one of the switching elements to a pixel electrode; and a fourth wiring being provided in a layer different from a layer including the third wiring, so as to at least partially overlap the third wiring.

### Advantageous Effects of Invention

An aspect of the present invention produces advantageous effects of preventing production yield from being reduced due to a line defect, and also of ensuring a high pixel aperture ratio.

### BRIEF DESCRIPTION OF DRAWINGS

FIG. 1 is a block diagram illustrating a main configuration of a liquid crystal panel in accordance with Embodiment 1 of the present invention.

FIG. 2A is a plan view illustrating a detailed, planar configuration of a pixel. FIG. 2B is a cross-sectional view taken along line X-X of FIG. 2A (which illustrates a current path over which a current flows in a case where a second drain line is disconnected).

FIG. 3 is an enlarged view of section B in FIG. 2A.

FIG. 4 is a plan view illustrating a pixel electrode of a liquid crystal panel.

FIG. 5 is a cross-sectional view illustrating a light shielding film of a liquid crystal panel.

FIG. 6 is a flowchart showing a flow of a process for forming, for example, individual wirings on a first substrate.

FIG. 7 is a plan view illustrating a planar configuration of a pixel of a liquid crystal panel in accordance with Embodiment 2 of the present invention.

FIG. 8 is a plan view illustrating a pixel electrode of the liquid crystal panel of FIG. 7.

FIG. 9 is a view for explaining how liquid crystal molecules are oriented upon application of a voltage to a corresponding pixel electrode.

FIG. 10 is a cross-sectional view illustrating a common electrode of a liquid crystal panel in accordance with Embodiment 3 of the present invention.

FIG. 11 is a plan view illustrating a pixel electrode of the liquid crystal panel in FIG. 10.

FIG. 12A is a plan view illustrating a planar configuration of a pixel of a liquid crystal panel in accordance with Comparative Example 1. FIG. 12B is a cross-sectional view taken along line Z-Z of FIG. 12A (which illustrates a state in which a drain line is disconnected).

FIG. 13 is a cross-sectional view of a liquid crystal panel in accordance with Comparative Example 2.

### DESCRIPTION OF EMBODIMENTS

### Embodiment 1

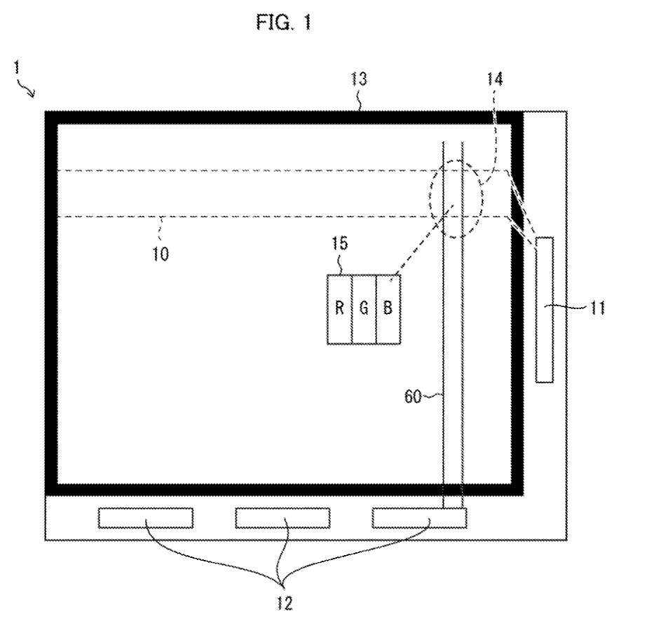

The following description will discuss Embodiment 1 of the present invention, with reference to FIGS. 1 through 6.

(Configuration of Liquid Crystal Panel 1)

FIG. 1 is a block diagram illustrating a main configuration of a liquid crystal panel 1 in accordance with Embodiment 1 of the present invention. As illustrated in FIG. 1, the liquid crystal panel 1 includes a gate driver 11, a source driver 12, a plurality of gate lines 10 (first wirings 220) and a plurality of source lines (second wirings) 60. The gate lines 10 are provided in a display region 13 so as to extend in a horizontal direction, and the source lines 60 are provided in the display region 13 so as to extend in a vertical direction orthogonal to the gate lines 10. In each intersection region 14, at which the respective gate lines 10 intersect the respective source lines 60, a pixel 15 is provided. The pixel 15 is constituted by three sub-pixels, a red sub-pixel (R), a blue sub-pixel (B), and a green sub-pixel (G). This allows the liquid crystal panel 1 to provide color display. The gate driver 11 is connected to the gate lines 10 so as to supply a gate signal to a corresponding one of the gate lines 10. The source driver 12 is connected to the source lines 60 so as to supply a source signal (data signal) to a corresponding one of the source lines 60.

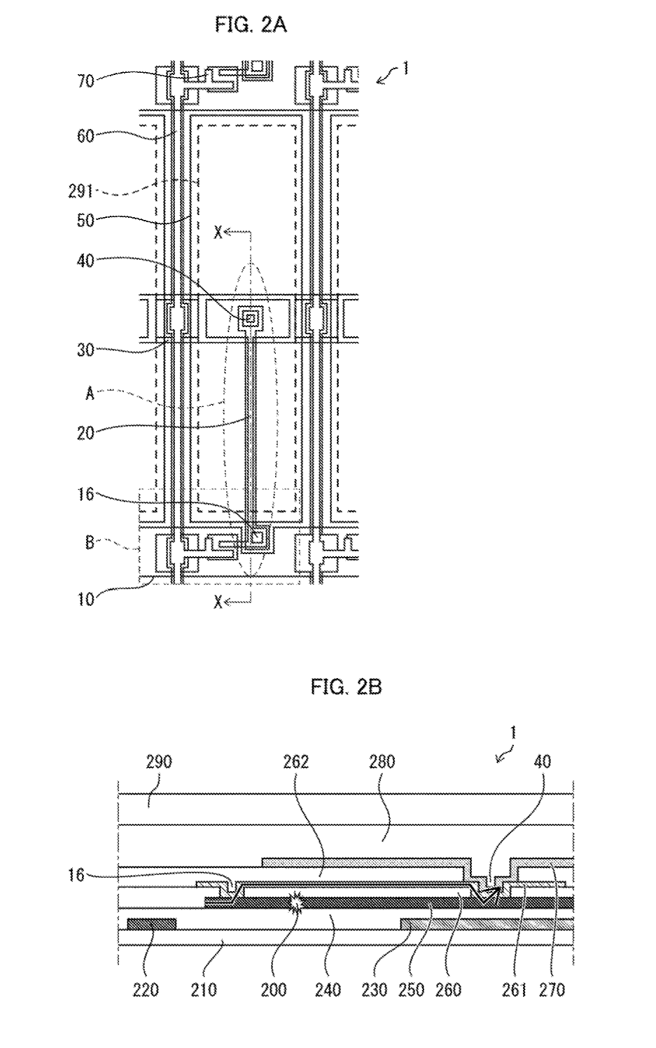

FIG. 2A is a plan view illustrating a detailed, planar configuration of a pixel. FIG. 2B is a cross-sectional view taken along line X-X of FIG. 2A (which illustrates a current path over which a current flows in a case where a second drain line is disconnected). As illustrated in FIG. 2A to FIG. 2B, the liquid crystal panel 1 includes an array substrate 210 (first substrate) and a counter substrate 290 (second substrate). Liquid crystal 280 is sandwiched between the first substrate 210 and the second substrate 290. The first substrate 210 has provided thereon the following components: the plurality of first wirings 220 (corresponding to the gate lines 10 in FIG. 2A); the plurality of second wirings (source lines) 60 which intersect the first wirings via a first interlayer insulating film 240; a plurality of switching elements 70 which are provided near intersections between the first wirings and the second wirings; a third wiring 250 (drain line 20), which extends from the switching element 70 to a pixel electrode 50 (pixel electrode 270); and a fourth wiring 261 (drain line 20), which is provided in a layer different from a layer including the third wiring 250, so as to at least partially overlap the third wiring 250.

The drain line 20 has a portion substantially parallel, in plan view, to the source line 60. The pixel electrode 50 is constituted by, for example, an ITO- or IZO-based transparent conductive film. Note that the second substrate 290 has a color filter and a black matrix (later described) provided thereon on the liquid crystal 280 side. The color filter has a common electrode (not illustrated) provided thereon on the liquid crystal 280 side.

Molecules of the liquid crystal 280, sandwiched between the common electrode and the pixel electrode 270, are oriented in accordance with a potential of a pixel signal. An amount of light, emitted from a backlight (not illustrated) on a rear side of the liquid crystal panel 1 and then allowed to pass through each pixel, is controlled (i) by using polarizing plates provided on the first substrate 210 side and the second substrate 290 side and (ii) by controlling orientation of the liquid crystal 280.

In the liquid crystal panel 1, the fourth wiring 261 (drain line 20) is provided in parallel to the third wiring 250 (see FIG. 2A to FIG. 2B).

In the liquid crystal panel 1, the pixel electrode 270(50) is provided on a third interlayer insulating film 262 which covers the fourth wiring 261 (see FIG. 2A to FIG. 2B).

The liquid crystal panel 1 further includes a fifth wiring 230 (auxiliary capacitor line 30) (see FIG. 2A to FIG. 2B). The fifth wiring 230 is provided in parallel to the first wiring 220. A first contact hole 16 is provided in a second interlayer insulating film (interlayer insulating film) 260, with which the third wiring 250 is covered. The first contact hole 16 is located closer to the first wiring 220 than to the fifth wiring 230. A second contact hole 40 is formed in the second interlayer insulating film 260, at a position corresponding to the fifth wiring 230. The third wiring 250 and the fourth wiring 261 are connected together via the first contact hole 16 and the second contact hole 40.

On the first substrate 210, provided are the gate line 220 and the auxiliary capacitor line 230. The gate line 220 extends in a horizontal direction. The auxiliary capacitor line 230 extends in parallel to the gate line 220. The first interlayer insulating film 240 is provided such that the gate line 220 and the auxiliary capacitor line 230 are covered with the first interlayer insulating film 240. The third wiring 250 is provided on the first interlayer insulating film 240. The switching element 70 can be realized by, for example, a thin film transistor (TFT) configured by oxide semiconductor. The TFT is a member for controlling a signal of a corresponding pixel 15. The TFT is provided near each intersection between the respective gate lines 10 and the respective source lines 60.

The second interlayer insulating film 260 is provided such that the third wiring 250 is partially covered with the second interlayer insulating film 260. The fourth wiring 261 is provided on the second interlayer insulating film 260. The second interlayer insulating film 260 has provided therein the first contact hole 16 and the second contact hole 40. The fourth wiring 261 is connected, via the contact holes 16 and 40, to the third wiring 250. The third wiring 250 and the fourth wiring 261 are provided opposite to each other. The pixel electrode 270(50) is connected to the fourth wiring 261 via a contact hole which is provided in the third interlayer insulating film 262 at a position corresponding to the second contact hole 40. Specifically, the pixel electrode 270(50) is connected to the switching element 70 via the fourth wiring 261 and the third wiring 250. With a contact hole provided at a position corresponding to the second contact hole 40 so as to connect the pixel electrode 270 and the fourth wiring 261, it is possible to more effectively prevent reduction in pixel aperture ratio and deterioration in display quality. Note that, although not illustrated in FIG. 2A to FIG. 2B, the liquid crystal panel 1 includes alignment films which are provided on opposite sides of the liquid crystal 280.

A pixel signal is supplied from the source line 60 via a TFT that serves as the switching element 70. This determines a signal potential of the pixel electrode 50 (270) which is conductive with a drain electrode (an electrode facing a source electrode that is connected to the source line 60) of the TFT via the third wiring 250, the contact holes 16 and 40, and the fourth wiring 261.

(Current Path)

FIG. 2A to FIG. 2B is a view illustrating a current path over which a current flows in a case where a disconnection 200 occurs in the third wiring 250 (lower drain line). As illustrated in FIG. 2A to FIG. 2B, the liquid crystal panel 1 is configured such that the third wiring 250 and the fourth wiring 261 (upper drain line) are connected together via the contact holes 16 and 40. This allows the liquid crystal panel 1 to have a current path (indicated by an arrow in FIG. 2B) which runs from the third wiring 250 to the fourth wiring 261 and then back to the third wiring 250. With this configuration, even in a case where the disconnection 200 occurs in the third wiring 250 as illustrated in FIG. 2A to FIG. 2B, a current applied to the third wiring 250 can flow normally through the current path. This allows the liquid crystal panel 1 to be of good quality, unless the third wiring 250 and the fourth wiring 261 are disconnected at the same time. Consequently, it is possible to realize the liquid crystal panel 1 which prevents its production yield from being reduced due to a pixel defect caused by a line defect (disconnection of a drain line), and also to ensure a high pixel aperture ratio.

(Region for Drain Cut-Off)

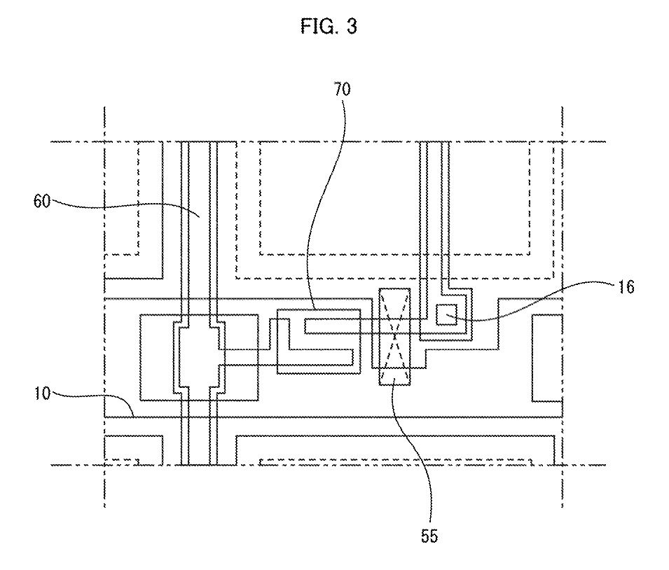

The following description will discuss a region for drain cut-off, with reference to FIG. 3. FIG. 3 is an enlarged view of section B in FIG. 2A. As illustrated in FIG. 3, the liquid crystal panel 1 has a cut-off region 55 between the first contact hole 16 and the switching element 70. At this cut-off region, at least a part of the third wiring 250 is electrically separated from the switching element 70, for example, by use of a laser.

In a case where a larger amount of leakage current is continuously generated between the source line 60 and the pixel electrode 270(50) due to, for example, malfunction of the switching element 70, a pixel, which is originally displayed in black, often appears as a luminous dot. In such a case, it is necessary to make a correction for a black dot by a drain cut-off process. The drain cut-off process is to cut a portion of a drain line so as to electrically separate a target pixel electrode from a corresponding switching element. In a normally black mode in which dark display is provided when no voltage is applied to a liquid crystal layer, the luminous dot becomes less visible by making a correction of the luminous dot for a black dot (dark display). In this case, with the cut-off region 55 for drain cut-off provided between the first contact hole 16 and the switching element 70, it is possible to make a correction for a black dot. This configuration is advantageous in saving production costs.

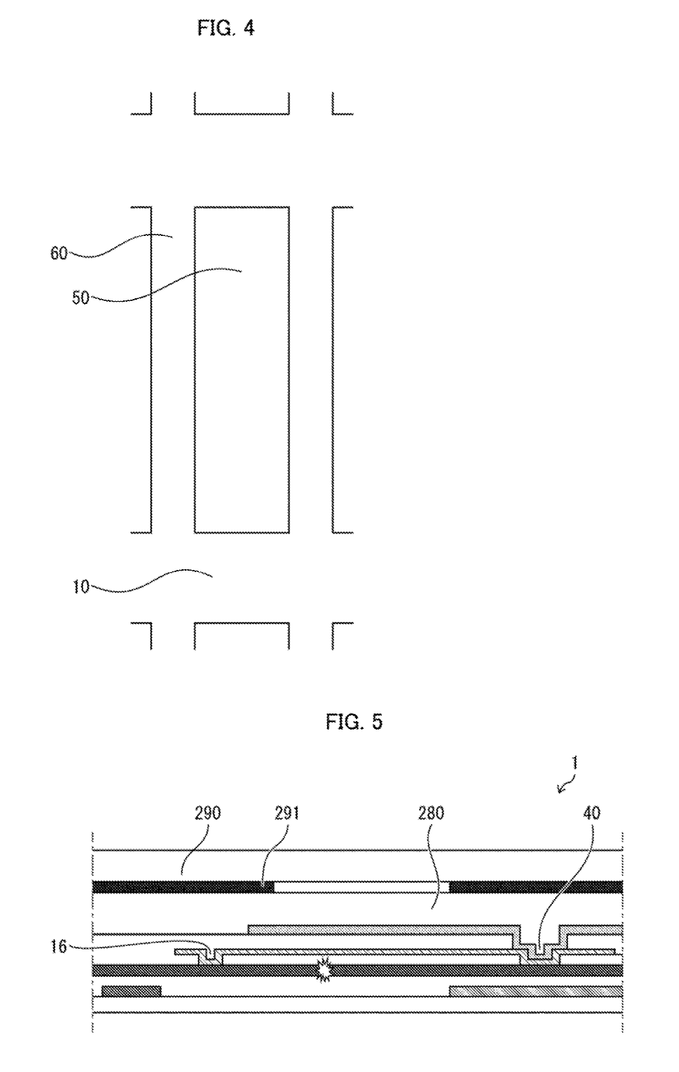

FIG. 4 is a plan view illustrating the pixel electrode 50 of the liquid crystal panel 1. As illustrated in FIG. 4, the pixel electrode 50 is configured as a so-called solid electrode.

Note that the fourth wiring 261 can be formed of the same material (e.g., an ITO- or IZO-based transparent conductive film) as the pixel electrode 50 (270). Alternatively, the fourth wiring 261 can be formed of an Al- or Cu-based material in order to reduce its resistance.

(Light Shielding Film)

The following description will discuss a light shielding film 291 with reference to FIG. 5. FIG. 5 is a cross-sectional view illustrating the light shielding film 291 of the liquid crystal panel 1. As illustrated in FIG. 5, the liquid crystal panel 1 is configured such that the light shielding film 291 (black matrix) is provided underneath the second substrate 290 oppositely to the first contact hole 16 and the second contact hole 40.

(Process Flow)

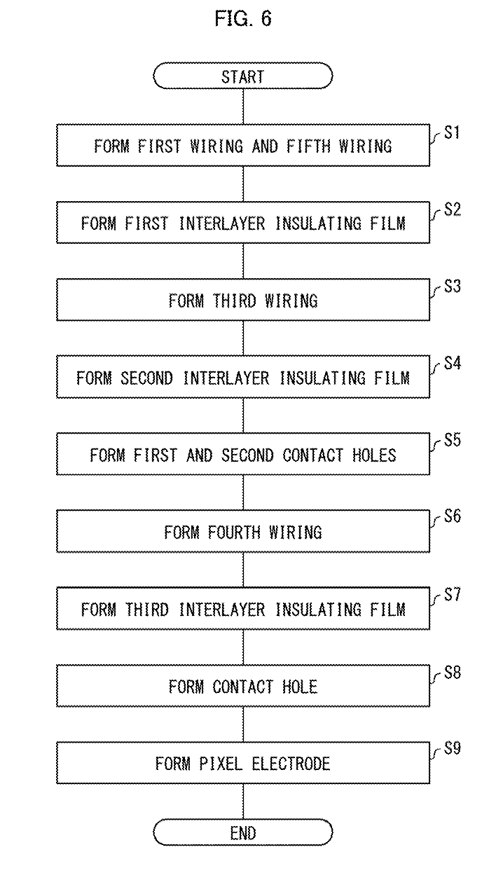

FIG. 6 is a flowchart showing a flow of a process for forming individual wirings on the first substrate 210. Steps in the flowchart are automatically carried out by, for example, a manufacturing apparatus equipped with a control section.

When the process of FIG. 6 is started, the first wiring 220 and the fifth wiring 230 are first formed on the surface of the first substrate 210 (step S1). Next, the first interlayer insulating film 240 is formed such that the first wiring 220 and the fifth wiring 230 are covered with the first interlayer insulating film 240 (step S2). Subsequently, the second wiring 60 and the third wiring 250 are formed on the first interlayer insulating film 240 (step S3). Then, the second interlayer insulating film 260 is formed such that the second wiring 60 and the third wiring 250 are covered with the second interlayer insulating film 260 (step S4). Next, the first contact hole 16 and the second contact hole 40 are formed in the second interlayer insulating film 260 (step S5). Subsequently, the fourth wiring 261 is formed on the second interlayer insulating film 260 (step S6). Then, the third interlayer insulating film 262 is formed such that the fourth wiring 261 is covered with the third interlayer insulating film 262, and another contact hole is formed at a position corresponding to the second contact hole 40 (steps S7 and S8). After that, the pixel electrode 270 is formed on the third interlayer insulating film 262 (step S9)

During the production of the liquid crystal panel 1, the contact holes 16 and 40 can be formed through the same photolithography step.

As discussed above, the configuration of Embodiment 1 realizes the liquid crystal panel 1 which makes it possible to prevent its production yield from being reduced due to a line defect, and also to ensure a high pixel aperture ratio. Another advantageous effect of this configuration is that a liquid crystal display device (not illustrated) including the liquid crystal panel 1 also makes it possible to prevent its production yield from being reduced due to a line defect and also to ensure a high pixel aperture ratio, similarly to the liquid crystal panel 1.

### Embodiment 2

The following description will discuss Embodiment 2 of the present invention, specifically focusing on differences from Embodiment 1. A main difference between Embodiments 1 and 2 resides in shape of a pixel electrode.

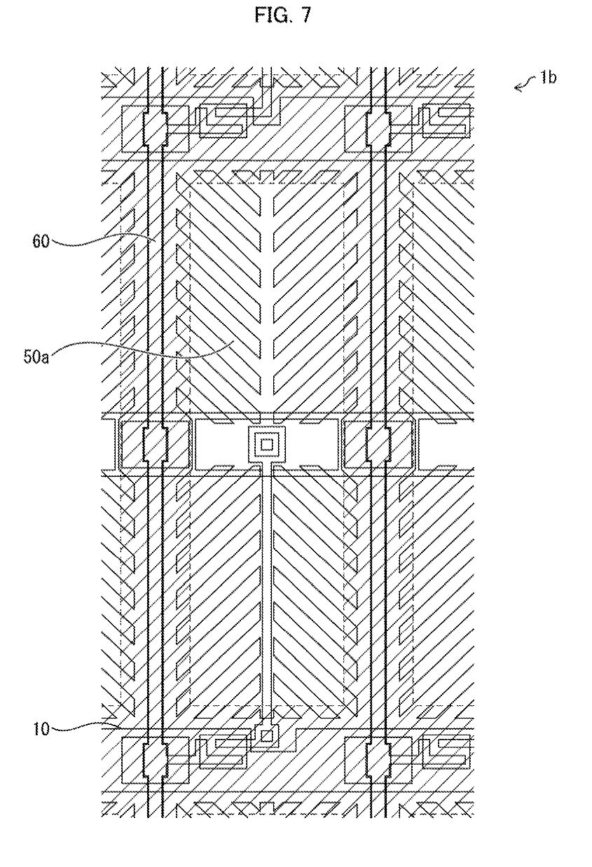

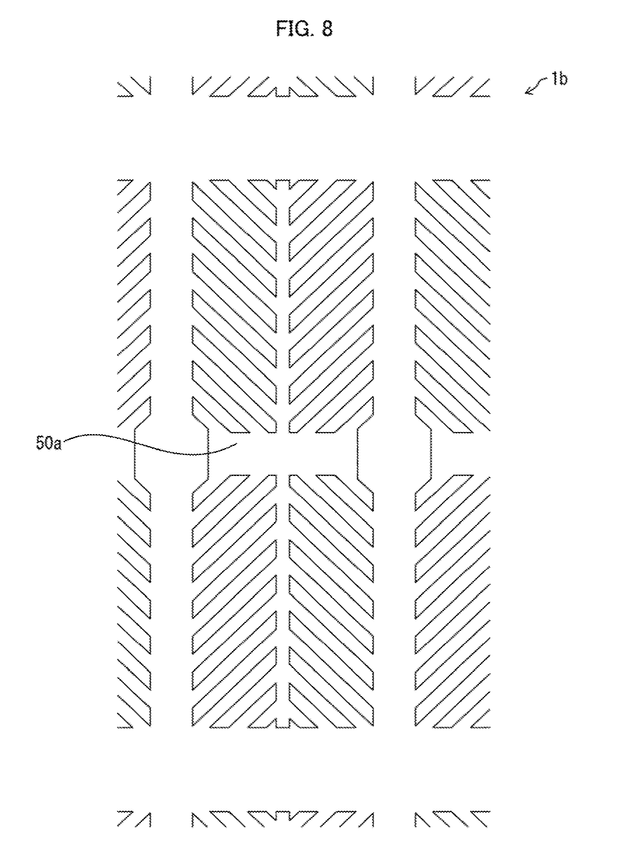

Referring to FIGS. 7 through 9, Embodiment 2 of the present invention is described. In Embodiment 2, the same members as those of Embodiment 1 are given the same reference signs and their detailed descriptions will be omitted.

(Configuration of Liquid Crystal Panel 1b)

FIG. 7 is a plan view illustrating a planar configuration of a pixel of a liquid crystal panel 1b in accordance with Embodiment 2 of the present invention. The liquid crystal panel 1b includes the same components as those constituting the liquid crystal panel 1 in accordance with Embodiment 1. Note that the liquid crystal panel 1b differs from the liquid crystal panel 1 in shape of a pixel electrode 50a.

FIG. 8 is a plan view illustrating the pixel electrode 50a. As illustrated in FIG. 8, the pixel electrode 50a has a so-called fish bone shape. The liquid crystal panel 1b operates in a vertical alignment (VA) mode. In a case of applying a voltage to liquid crystal 280, controlled by a vertical alignment film, molecules of the liquid crystal 280 are oriented as if leaning toward the inner side of the pixel electrode 50a, starting from the outermost molecules at the ends of branch portions of the pixel electrode 50a.

(Orientation Direction of Liquid Crystal 280)

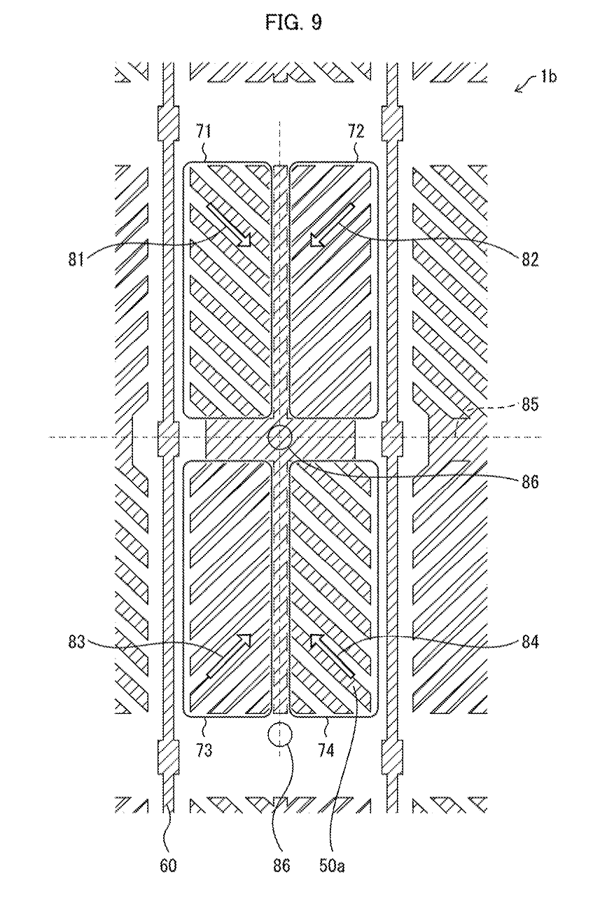

FIG. 9 is a view for explaining how molecules of the liquid crystal 280 are oriented upon the application of a voltage to a corresponding pixel electrode 50a. The pixel electrode 50a is divided into four regions 71 to 74 (see FIG. 9). Upon the application of a voltage to the liquid crystal 280, molecules of the liquid crystal 280 in regions corresponding to the regions 71 to 74 are oriented, respectively, as if leaning in four different orientation directions 81 to 84, which are inward directions of the pixel electrode 50a. By thus controlling the molecules of the liquid crystal 280 to be oriented in the four different directions, the liquid crystal 280 can reduce its viewing angle dependence. This allows the liquid crystal panel 1b to realize uniform display within a wider range of viewing angle.

A cross region 85 constituting a trunk portion of the pixel electrode 50a, in which the molecules of the liquid crystal 280 are oriented in different directions while colliding with each other, often appears as a dark line on the liquid crystal panel 1b. The dark line refers to a portion where control of the liquid crystal 280 is so difficult that sufficient light transmittance cannot be obtained. Embodiment 2 assumes that a contact hole is provided in an ineffective pixel region 86 within the cross region 85. This makes it possible to prevent reduction in aperture ratio of each pixel 15.

It is also possible to stabilize the orientation of the liquid crystal 280 in the liquid crystal panel 1b, for example, through a PSA process. The PSA process applied to the liquid crystal panel 1b is to (i) fill a monomer-containing liquid crystal material into the liquid crystal panel 1b and (ii) irradiate UV light thereto, for example, while applying a voltage to the pixel 15, so as to promote polymerization of the liquid crystal 280 at an interface with the alignment film. This process ensures that, in a liquid crystal mode in which the molecules of the liquid crystal 280 are oriented with use of a vertical alignment film, the molecules of the liquid crystal 280 are initially oriented with a certain inclination angle. In this case, the molecules of the liquid crystal 280 can be oriented uniformly, not randomly, and the display quality is improved. Also, a response speed for display and light transmittance are improved.

The liquid crystal panel 1b in accordance with Embodiment 2 has the same configuration as that of Embodiment 1. Specifically, the liquid crystal panel 1b includes: a first substrate 210; a second substrate 290; and the liquid crystal 280 being provided between the first substrate 210 and the second substrate 290, wherein the first substrate 210 has provided thereon the followings: a plurality of first wirings 220; a plurality of second wirings 60 each intersecting a corresponding one of the first wirings 220 via a first interlayer insulating film 240; a plurality of switching elements 70 each being provided near a corresponding one of intersections between the first wirings 220 and the second wirings 60; a third wiring 250 extending from a corresponding one of the switching elements 70 to a pixel electrode; and a fourth wiring 261 being provided in a layer different from a layer including the third wiring, so as to at least partially overlap the third wiring.

As discussed above, the configuration of Embodiment 2 also realizes the liquid crystal panel 1b which makes it possible to prevent its production yield from being reduced due to a line defect and also to ensure a high pixel aperture ratio. Another advantageous effect of this configuration is that a liquid crystal display device (not illustrated) including the liquid crystal panel 1b also makes it possible to prevent its production yield from being reduced due to a line defect and also to ensure a high pixel aperture ratio, similarly to the liquid crystal panel 1b.

The other components described in Embodiment 1 are also applicable to Embodiment 2.

### Embodiment 3

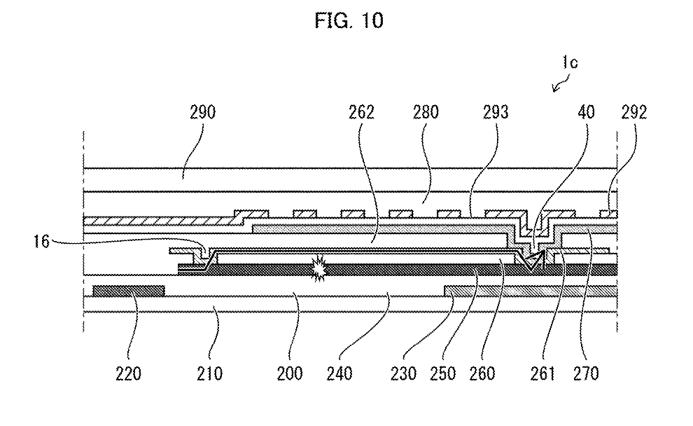

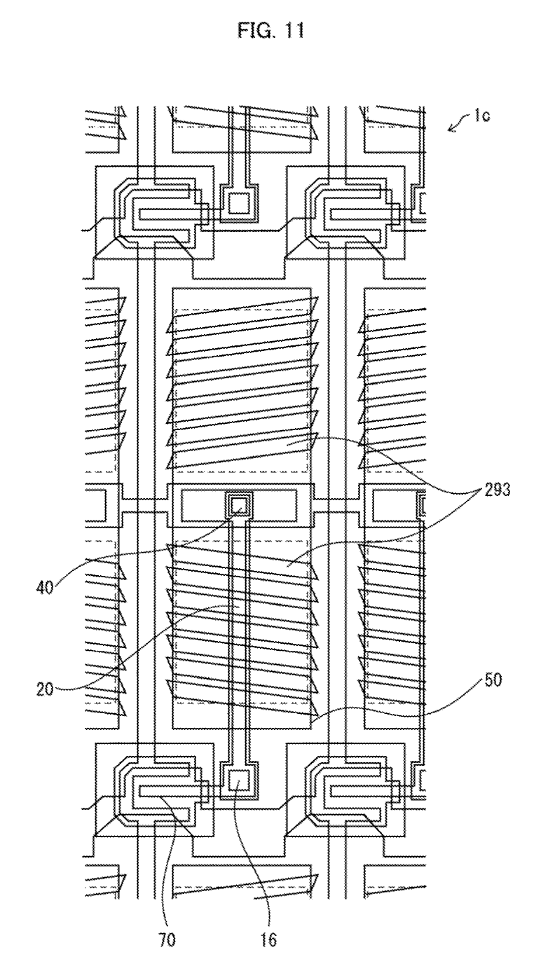

The following description will discuss Embodiment 3 of the present invention, with reference to FIGS. 10 and 11. In Embodiment 3, the same members as those of Embodiments 1 and 2 are given the same reference signs and their detailed descriptions will be omitted.

(Common Electrode)

The following will describe a common electrode 292 in a transverse electric field mode, e.g., a fringe field switching (FFS) mode, with reference to FIG. 10. FIG. 10 is a cross-sectional view illustrating the common electrode 292 of a liquid crystal panel 1c. In FIG. 2A to FIG. 2B, the common electrode, for applying a voltage to the liquid crystal between the common electrode and the pixel electrode, is provided on the second substrate 290 on the liquid crystal 280 side, whereas in FIG. 10, the common electrode is provided on a first substrate 210. In the liquid crystal panel 1c, the common electrode 292 is provided on a fourth wiring on the liquid crystal 280 side, via an insulating film (see FIG. 10). The common electrode 292 is constituted by, for example, an ITO- or IZO-based transparent conductive film. The common electrode 292 has a slit 293 facing a pixel electrode 270. The common electrode 292 generates, together with the pixel electrode 270, a fringe electric field via the slit 293, so as to control orientation of the liquid crystal.

Further, the fringe electric field, which is generated between the common electrode 292 and the pixel electrode 270 via the slit 293, allows molecules of the liquid crystal 280 to be oriented in accordance with a potential of a corresponding pixel signal. An amount of light, emitted from a backlight (not illustrated) on a rear side of the liquid crystal panel 1c and then allowed to pass through each pixel, is controlled (i) by using polarizing plates provided on the first substrate 210 side and the second substrate 290 side and (ii) by controlling orientation of the liquid crystal 280.

As illustrated in FIG. 10, the common electrode 292 is provided oppositely to a first contact hole 16 and a second contact hole 40.

(Configuration of Liquid Crystal Panel 1c)

FIG. 11 is a plan view illustrating a planar configuration of the liquid crystal panel 1c in accordance with Embodiment 3 of the present invention. The liquid crystal panel 1c includes at least the same components as those constituting the liquid crystal panel 1 in accordance with Embodiment 1. Note that the liquid crystal panel 1c differs from the liquid crystal panel 1 in orientation mode of the liquid crystal 280. The liquid crystal panel 1c supports a transverse electric field mode, i.e., an FFS mode. The pixel electrode 270(50) does not have any slit as in Embodiment 1, while the common electrode 292 has a slit which is inclined, at a certain angle, with respect to a gate line 220 and also which is substantially parallel to a horizontal direction (direction in which the gate line 220 extends).

Even in this configuration, a drain line 20 may be disconnected in a case where a switching element 70 is far from the contact hole 40, through which the switching element 70 and the pixel electrode 50 are connected together, that is, in a case where the drain line 20 is long. Thus, in this configuration, the configuration of Embodiment 1 (see FIG. 2A to FIG. 2B) can be applied to a portion between the switching element 70 and the contact hole 40 through which the switching element 70 and the pixel electrode 50 are connected together.

The above configuration also produces the same effects as those of Embodiments 1 and 2.

### Comparative Examples

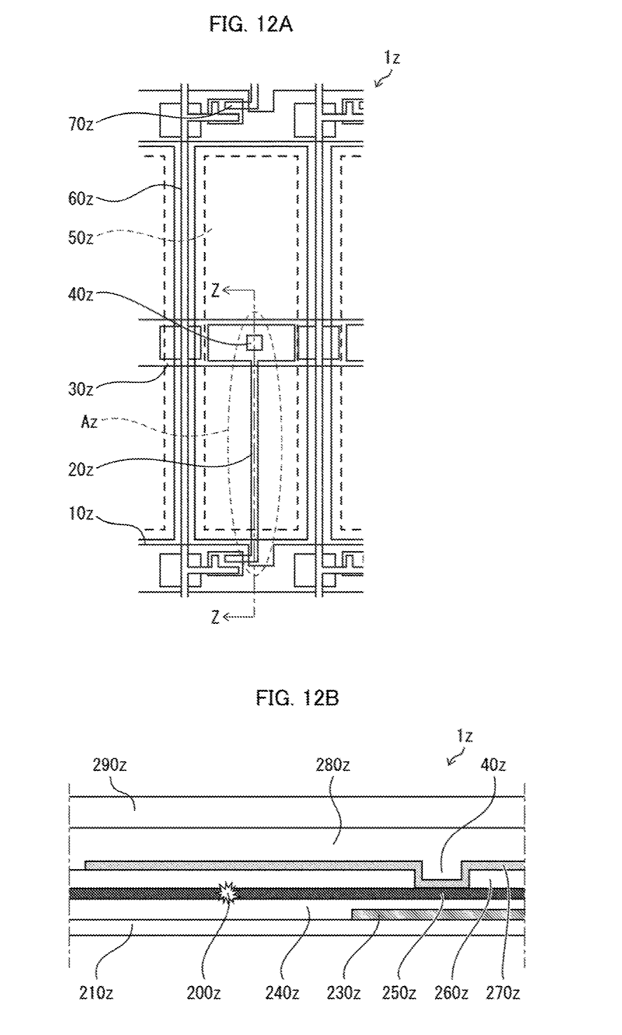

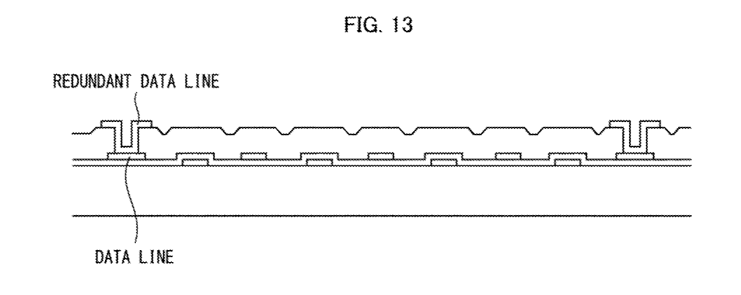

The following description will discuss comparative examples, with reference to FIGS. 12A, 12B, and 13. FIG. 12A is a plan view illustrating a planar configuration of a pixel of a liquid crystal panel 1n accordance with Comparative Example 1. FIG. 12B is a cross-sectional view taken along line Z-Z of FIG. 12A (which illustrates a state in which a drain line is disconnected). FIG. 13 is a cross-sectional view of a liquid crystal panel 1n accordance with Comparative Example 2.

According to a configuration illustrated in FIG. 12A to FIG. 12B, in a case where a drain line 250z of a liquid crystal panel 1z is disconnected, a signal cannot be supplied to a pixel electrode, with the result that a production yield is reduced.

According to a configuration illustrated in FIG. 13, a data line and a redundant data line are provided. The redundant data line is provided on the data line via an insulating film. The data line and the redundant data line are connected together via a contact hole.

Neither Comparative Example 1 nor Comparative Example 2 has the configuration discussed in the foregoing embodiments of the present invention. Thus, neither of them produces the advantageous effects unique to the embodiments of the present invention.

[Recap]

A liquid crystal panel (1) in accordance with a first aspect of the present invention includes: a first substrate (210); a second substrate (290); and liquid crystal (280) being provided between the first substrate and the second substrate, wherein the first substrate has provided thereon the followings: a plurality of first wirings (220); a plurality of second wirings (60) each intersecting a corresponding one of the first wirings via a first interlayer insulating film (240); a plurality of switching elements (70) each being provided near a corresponding one of intersections between the first wirings and the second wirings; a third wiring (250) extending from a corresponding one of the switching elements to a pixel electrode; and a fourth wiring (261) being provided in a layer different from a layer including the third wiring, so as to at least partially overlap the third wiring.

The above configuration makes it possible to prevent reduction in production yield caused by a line defect and also to ensure a high pixel aperture ratio.

In a second aspect of the present invention, a liquid crystal panel may be configured such that, in the first aspect, the fourth wiring (261) is provided in parallel to the third wiring (250).

The above configuration makes it possible to prevent reduction in production yield caused by a line defect and also to ensure a higher pixel aperture ratio.

In a third aspect of the present invention, a liquid crystal panel may be configured, in the first or second aspect, to further include a fifth wiring (230) which is provided in parallel to the first wiring (220), a first contact hole (16) being provided in a second interlayer insulating film (260) with which the third wiring is covered, at a position closer to the first wiring than to the fifth wiring, a second contact hole (40) being provided in the second interlayer insulating film, at a position corresponding to the fifth wiring, and the third wiring and the fourth wiring being connected together via the first contact hole (16) and the second contact hole (40).

The above configuration allows the third wiring and the fourth wiring to be connected together via the first contact hole (16) and the second contact hole (40).

In a fourth aspect of the present invention, a liquid crystal panel may be configured such that, in the third aspect, a cut-off region (55) is provided between the first contact hole and a corresponding one of the switching elements, at which region at least a portion of the third wiring is electrically separated from the switching element.

The above configuration makes it possible to make a correction of a line defect, which appears as a luminous dot, for a black dot. This is advantageous in saving production costs.

In a fifth aspect of the present invention, a liquid crystal panel may be configured such that, in the third or fourth aspect, the first wirings are gate lines, the second wirings are source lines, the third wiring is a first drain line, the fourth wiring is a second drain line, and the fifth wiring is an auxiliary capacitor line.

In a sixth aspect of the present invention, a liquid crystal panel may be configured such that, in any one of the third through fifth aspects, a light shielding film (291) (black matrix) is provided underneath the second substrate oppositely to the first contact hole (16) and the second contact hole (40).

In a seventh aspect of the present invention, a liquid crystal panel may be configured such that, in any one of the third through sixth aspects, a common electrode (292) is provided on the fourth wiring on the liquid crystal side, via an insulating film.

In an eighth aspect of the present invention, a liquid crystal panel may be configured such that, in the seventh aspect, the common electrode is provided oppositely to the first contact hole (16) and the second contact hole (40).

In a ninth aspect of the present invention, a liquid crystal panel may be configured such that, in the seventh or eighth aspect, the common electrode has a slit (293) facing the pixel electrode.

In a tenth aspect of the present invention, a liquid crystal panel may be configured such that, in any one of the first through ninth aspects, the pixel electrode is provided on a third interlayer insulating film (262) with which the fourth wiring is covered.

In an eleventh aspect of the present invention, a liquid crystal panel may be configured such that, in any one of the first through tenth aspect, the fourth wiring contains a material identical with a material of the pixel electrode.

The above configuration realizes a simple manufacturing process for a liquid crystal panel.

A liquid crystal display device in accordance with a twelfth aspect of the present invention includes the liquid crystal panel described in any one of the first through eleventh aspects.

The above configuration realizes a liquid crystal display device which makes it possible to prevent its production yield from being reduced due to a line defect and also to ensure a high pixel aperture ratio.

The present invention is not limited to the above embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 1a, 1b, 1c, 1z Liquid crystal panel
11 Gate driver
12 Source driver
13 Display region
14 Intersection
15 Pixel
16, 45 Contact hole
60 Source line
70 TFT
200 Disconnection
210 First substrate
10, 220 Gate line
30, 230 Auxiliary capacitor line
240 First interlayer insulating film
20, 250, 261 Drain line
260 Second interlayer insulating film
50, 50a, 270 Pixel electrode
280 Liquid crystal
290 Second substrate
291 Black matrix
292 Common electrode
293 Slit

1. A liquid crystal panel, comprising:
a first substrate;
a second substrate; and
liquid crystal being provided between the first substrate and the second substrate,
wherein the first substrate has provided thereon the followings:
a plurality of first wirings;
a plurality of second wirings each intersecting a corresponding one of the first wirings via a first interlayer insulating film;
a plurality of switching elements each being provided near a corresponding one of intersections between the first wirings and the second wirings;
a third wiring extending from a corresponding one of the switching elements to a pixel electrode; and
a fourth wiring being provided in a layer different from a layer including the third wiring, so as to at least partially overlap the third wiring.

2. The liquid crystal panel as set forth in claim 1, wherein the fourth wiring is provided in parallel to the third wiring.

3. The liquid crystal panel as set forth in claim 1, further comprising a fifth wiring which is provided in parallel to the first wiring,
a first contact hole being provided in a second interlayer insulating film with which the third wiring is covered, at a position closer to the first wiring than to the fifth wiring,
a second contact hole being provided in the second interlayer insulating film, at a position corresponding to the fifth wiring, and
the third wiring and the fourth wiring being connected together via the first contact hole and the second contact hole.

4. The liquid crystal panel as set forth in claim 3, wherein a cut-off region is provided between the first contact hole and a corresponding one of the switching elements, at which region at least a portion of the third wiring is electrically separated from the switching element.

5. The liquid crystal panel as set forth in claim 3, wherein
the first wirings are gate lines,
the second wirings are source lines,
the third wiring is a first drain line,
the fourth wiring is a second drain line, and
the fifth wiring is an auxiliary capacitor line.

6. The liquid crystal panel as set forth in claim 3, wherein a light shielding film is provided underneath the second substrate oppositely to the first contact hole and the second contact hole.

7. The liquid crystal panel as set forth in claim 3, wherein a common electrode is provided on the fourth wiring on the liquid crystal side, via an insulating film.

8. The liquid crystal panel as set forth in claim 7, wherein the common electrode is provided oppositely to the first contact hole and the second contact hole.

9. The liquid crystal panel as set forth in claim 7, wherein the common electrode has a slit facing the pixel electrode.

10. The liquid crystal panel as set forth in claim 1, wherein the pixel electrode is provided on a third interlayer insulating film with which the fourth wiring is covered.

11. The liquid crystal panel as set forth in claim 1, wherein the fourth wiring contains a material identical with a material of the pixel electrode.

12. A liquid crystal display device, comprising the liquid crystal panel recited in claim 1.
